(19) United States
(12) Patent Application Publication
(10) Pub. No.: US 2003/0066322 A1
(43) Pub. Date: Apr. 10, 2003

(54) Microbiologically accelerated humus and method and apparatus for producing same

(76) Inventor: Felix Anthony Perriello, Norwood, MA (US)

Correspondence Address: Robert P. Lenart, Pietragallo, Bosick & Gordon, One Oxford Centre, 38th Floor, 301 Grant Street, Pittsburgh, PA, 15219, US

(21) Appl. No.: 10/144,079

(22) Filed: May 13, 2002

Related U.S. Application Data
(60) Provisional application No. 60/291,123, filed on May 15, 2001.
(60) Provisional application No. 60/343,040, filed on Dec. 20, 2001.

(51) Int. Cl. C05F 11/02

(52) U.S. Cl. 71/24

(57) ABSTRACT

Microbiologically accelerated humus is produced by introducing an alkane and, optionally, an oxygen-containing gas into organic matter such as compost material, plant material or cellulosic material. The microbiologically accelerated humus can be mixed with a geologic mineral fraction such as sand, silt, clay and gravel to produce an agricultural-grade or engineered topsoil. The alkane can be introduced continuously or intermittently, and can comprise a butane substrate. Systems for producing microbiologically accelerated humus and topsoil are also included.

### CROSS REFERENCE TO RELATED APPLICATION

This application claims the benefit of U.S. Provisional Applications 60/291,123, filed May 15, 2001, and 60/343,040, filed Dec. 20, 2001.

### FIELD OF THE INVENTION

The present invention relates to the production of humus and soil through enhanced microbiological processes.

### BACKGROUND INFORMATION

Soil erosion is an important social and economic problem affecting crop output in the United States and worldwide. In the United States, soil has recently eroded at about 17 times the rate at which it forms. According to the United States Global Change Research Information Office, approximately 90% of United States cropland is currently losing soil above the sustainable rate. Soil erosion rates in Asia, Africa and South America are estimated to be about twice as high as in the United States. Erosion is a fundamental and complex natural process that is increased by human activities such as land clearance, agriculture (plowing, irrigation, grazing), forestry, construction, surface mining and urbanization. It is estimated that human activities have degraded some 15% of the earth's land surface; over half of this amount is a direct result of human-induced water erosion, while a third is due to wind erosion. Erosion of topsoil reduces the land's ability to produce crops. The loss of topsoil is a major problem threatening the welfare of human society.

Agricultural research has developed methods to control and prevent wind erosion and topsoil loss. Soil erosion (topsoil loss) has diminished through numerous improvements in farm machinery, crop varieties, fertilizers, herbicides and other crop amendments.

The formation of soil is a complex process. Soils are derived from rocks or materials containing a wide variety of minerals that are weathered to produce positive and negative charged ions that are released into soil water. The organic matter in soils includes plants, microbes, animals, and resistant organic compounds resulting from decomposition processes. Microorganisms in the soil decompose organic matter and convert unavailable nutrients in organic matter into ionic forms that plants can reuse.

Soil formation includes two broad processes: first, the formation of a parent material from which soil evolves and, second, the evolution of soil layers. Approximately 99% of the world's soils develop in mineral parent material that was derived from the weathering of bedrock. Depending on the type of parent material, it may take 10,000 years for weathering processes to produce an inch of topsoil.

Topsoil is a mineral horizon that forms at the soil surface and is characterized by an accumulation of humified organic matter (humus) intimately mixed with the mineral fraction. The texture of a soil is based on the relative proportions of sand, silt and clay. The mineral fraction of a high-grade topsoil may contain 40% sand, 40% silt and 20% clay. Humus includes organic compounds in the soil exclusive of undecayed plant and animal tissues, their partial decomposition products, and the soil biomass. Humus is very resistant to further microbial (enzymatic) action or degradation.

Most soil bacteria are heterotrophs capable of using organic carbon sources for energy and metabolism, thereby producing stable soil organic matter through the production of polysaccharides, hemicellulose and cellulose (found in microbial cell walls). Mineral weathering is stimulated by acid conditions. Respiration of microorganisms produces carbon dioxide that reacts with minerals to form carbon acid, thereby releasing plant-essential nutrient ions to the soil solution as clay minerals form (primary minerals degrade and secondary minerals such as clay accumulate).

It would be desirable to find a way to accelerate the formation of humus and soil. The present invention provides a method of producing humus and agricultural-grade topsoil by accelerating microbiological processes under controlled conditions.

### SUMMARY OF THE INVENTION

A process for producing microbiologically accelerated humus comprises the step of introducing an alkane into undecayed or partially decayed organic matter to produce microbiologically accelerated humus (MAH). An oxygen-containing gas may optionally be introduced into the organic matter to provide aerobic conditions. The alkane can be introduced continuously or intermittently, and can comprise a butane substrate. The butane substrate and the optional oxygen-containing gas can be mixed with each other prior to being introduced into the organic matter. The microbiologically accelerated humus can be mixed with a geologic mineral fraction and tumbled. The geologic mineral fraction can comprise sand, silt, clay and/or gravel.

A system for producing soil such as agricultural grade topsoil using the process is also included. The system includes means for introducing an alkane and, optionally, an oxygen-containing gas into organic matter to produce microbiologically accelerated humus. The system can further include means for mixing the microbiologically accelerated humus with a geologic mineral fraction to create engineered topsoil. The alkane can be introduced intermittently, and can comprise a butane substrate. The geologic mineral fraction can include sand, silt, clay and/or gravel. Mixing can be performed by tumbling the mixture of microbiologically accelerated humus, sand, silt, clay and/or gravel.

The invention further encompasses a system for treating organic matter comprising means for introducing a butane substrate into the organic matter to accelerate microbiologic activity in the organic matter. The system can further comprise means for introducing an oxygen-containing gas into the organic matter. The means for introducing a butane substrate into the organic matter can include a vessel for containing the organic matter, an inlet for receiving the butane substrate, and a diffuser for diffusing the butane substrate in the organic matter. The butane substrate can be introduced intermittently.

The invention also encompasses a process for producing soil comprising the step of introducing an alkane into undecayed or partially decayed organic matter to produce microbiologically accelerated humus (MAH), and mixing the microbiologically accelerated humus with a geologic mineral fraction. The alkane can be introduced intermittently, and can comprise a butane substrate. The geologic mineral fraction can comprise sand, silt, clay and/or gravel.

The invention further encompasses a system for producing soil including means for introducing an alkane into organic matter to produce microbiologically accelerated humus, and means for mixing the microbiologically accelerated humus with a geologic mineral fraction. The alkane can be introduced intermittently, and can comprise a butane substrate. The geologic mineral fraction can include sand, silt, clay and/or gravel. Mixing can be performed by tumbling the mixture of microbiologically accelerated humus, sand, silt, clay and/or gravel.

The invention also encompasses a process for producing microbiologically accelerated humus comprising the step of introducing an alkane into organic matter to produce microbiologically accelerated humus (MAH), wherein the organic matter includes compost material, plant material or cellulosic material. The process can be carried out aerobically or anaerobically. For an aerobic process, an oxygen-containing gas is also introduced into the organic matter. The alkane can be introduced continuously or intermittently, and can comprise a butane substrate. The microbiologically accelerated humus can be mixed with a geologic mineral fraction and tumbled. The geologic mineral fraction can comprise sand, silt, clay and/or gravel.

The invention further encompasses a microbiologically accelerated humus comprising alkane-treated, dewatered organic matter. The organic matter may include compost material, plant material and/or cellulosic material.

The invention further encompasses a digestion mass comprising alkane-utilizing bacteria and organic matter. The organic matter may include compost material, plant material and/or cellulosic material. The digestion mass can further include water.

The invention also encompasses a soil comprising microbiologically accelerated humus and a geologic fraction. The geologic fraction may include sand, silt, clay and/or gravel.

### BRIEF DESCRIPTION OF THE DRAWINGS

FIG. 1 is a flow diagram showing the steps used to produce agricultural-grade topsoil in accordance with an embodiment of the present invention;

FIG. 2 is a schematic representation of an aerobic digester that may be used in the performance of the method of the present invention;

FIG. 3 is a schematic representation of another digester that may be used in the performance of the method of the present invention;

FIG. 4 is a schematic representation of a tumbler that may be used in the performance of the method of the present invention;

FIG. 5 is a schematic top view of an experimental seed layout; and

FIG. 6 is a flow diagram showing the steps used to produce microbiologically accelerated humus in accordance with an embodiment of the present invention.

### DETAILED DESCRIPTION OF THE INVENTION

The present invention utilizes alkanes such as methane, ethane, propane or butane, preferably butane, to accelerate the decomposition of organic matter to produce microbiologically accelerated humus. In one embodiment, the microbiologically accelerated humus can be mixed with a geologic mineral fraction to produce soil such as agricultural-grade topsoil. FIG. 1 is a flow diagram showing the steps used to produce agricultural-grade topsoil in accordance with an embodiment of the present invention. Block 10 shows that organic matter can initially be placed in a vessel.

The organic matter can comprise numerous compounds such as compost material, plant material, cellulose-containing material, leaves, grass, tree or plant material, food, agricultural or horticultural wastes or byproducts, wheat straw, potato skins, industrial and municipal wastewater byproducts and/or sludges. Other sources include seafoods and seafood byproducts or wastes products, meat and meat byproducts and waste products, fresh, partially decayed or rotten fruits and vegetables, grain, cereals, livestock byproducts and waste products, farm supplies, byproducts or waste products, tobacco and its products, textile industries byproducts or waste products, cordage and twine, lumber, wood products, paper products, pulp mill products, boxes, leather and leather products.

The organic matter can also include agars, simple and complex sugars, carbohydrates, milk products, egg albumin, egg products, blood serums, urea broth, beet molasses, glucose, xylose and glucose, xylose, mannose, lactate, mannitol, yeast, yeast extract, sorbitol, wheat bran, straw, molasses, cereals, corn, potato starch, corn cob, fish meal, grain, gelatin, corn steep liquor, corn meal, nutrient gelatin, rice bran, casein hydrolysate, ethanol, agricultural residues, tree bark, peat moss, peat moss hydrolysate, lactose, sugar-cane syrup, synthetic ethanol, alkanes, n-alkanes, petroleum distillates, non-petroleum compounds, any soluble foodstuff, fructose, fatty acids, proteins, celluose, nitrates/nitrites/ammonia, maltose, sucrose, starch, acetate, glycerol, soluble starch, amino acids, casamino acids, urea, meat extracts, organic acids, barley, barley malt, blood meal, cane (black strap) molasses, cerelose, CFS concentrate, corn gluten meal, cotton seed meal, dried distillers' solubles, edamine, enzose, fermamin, fish solubles, fish meal, linseed meal, meat and bone meal, NZ-Amine B, oat flour, peanut meal and hulls, pharmamedia, rice flour, soybean meal, wheat flour, whey powder, Brewers' yeast, yeast hydrolysate, yeast tortula, arabinose, fumarate, pyruvate, succinate, phosphate, galactose, glycol, crotonate, glutamate, arginine, ribose, alcohols, hexadecanol, any microbial metabolite, carboxylic acids, acids such as formic, acetic, propionic, oxalic, acrylic, methacrylic, mineral spirits, mineral oils, petroleum jellies, mushroom extracts, mushrooms, grain dust, cheese whey, gas oils, cellulose-pulping, carbon dioxide, gas and oil, carob bean extract, waste starch, fermentation products, endogenous oxidized cell tissue, high molecular mass compounds, cell protoplasm, or dead microbial cells.

Composting material, plant material and/or cellulosic material are preferred organic materials which may be treated in accordance with the present invention to yield microbiologically accelerated humus.

An alkane is injected into the organic matter as shown in FIG. 1 in block 12. For aerobic treatment, an oxygen-containing gas may also be introduced into the organic matter. The introduction of oxygen-containing gas may be accomplished by any suitable means such as injection tubes for introducing the gas alone or in a carrier fluid, or by exposing the material to the atmosphere. The alkane and optional oxygen-containing gas injection is used to accelerate microbial humification processes in the organic matter. In one embodiment of the invention, the alkane is butane, but other compounds can be used such as methane, ethane, propane or any higher order alkane. As used herein, the term “butane substrate” includes liquids and gases in which butane is present in sufficient amounts to stimulate substantial growth of butane-utilizing bacteria. Butane is preferably the most prevalent compound of the butane substrate on a weight percent basis, and typically comprises at least about 10 weight percent of the butane substrate. The other constituents of the butane substrate may include other hydrocarbon compounds, such as other alkanes, i.e., methane, ethane and propane. The butane substrate preferably comprises at least about 50 weight percent butane. More preferably, the butane substrate comprises at least about 90 weight percent butane. In a particular embodiment, the butane substrate comprises at least about 99 weight percent n-butane. The butane may contain straight (n-butane) and/or branched chain compounds such as iso-butane.

Butane is highly soluble and ideally suited to serve as a microbial growth substrate, thereby significantly increasing the heterogeneous microbial community. The enhanced microbial population will rapidly absorb and mineralize the degradable and available dissolved organic nutrients in the organic matter, thus producing an organic mix that is very resistant to further microbial or enzymatic attack. The butane may be injected intermittently to create feeding/starvation cycles within the microbial community. After the initial growth phase, the organic matter available for further digestion will be rapidly decreased, thereby increasing dramatically the stability and overall resistance of the organic material.

In one embodiment, after digestion of the organic matter, the resulting microbiologically accelerated humus (MAH) may be mechanically combined with a geologic mineral fraction. This mixing can be accomplished by adding geologic mineral fraction components such as sand, silt, clay and/or gravel to the MAH as shown in block 14, and tumbling the mixture as shown in block 16. After the mixing is complete, the mixture is dewatered to produce the topsoil product as illustrated by block 18. A soil can comprise between about 5 weight percent and about 99 weight percent microbiologically accelerated humus, and between about 1 weight percent and about 95 weight percent geologic fraction. More preferably the microbiologically accelerated humus comprises from about 5 to about 99 weight percent of the soil, and the geologic fraction comprises from about 1 to about 95 weight percent of the soil.

Aerobic digestion is a method of degrading the organic material produced from various treatment processes. In accordance with a preferred embodiment of the present invention, butane, because of its solubility, rapidly dissolves in water, thereby significantly increasing the heterogeneous microbial community and heterotrophic microbial population found in decomposing organic material. Butane availability results in the selection of robust and diverse microbial populations. These enhanced microbial populations rapidly absorb and mineralize the dissolved organic nutrients in the organic material, thereby accelerating the decomposition of the available organic substrates. During and after this initial growth phase, the organic matter will steadily increase its resistance to microbial and enzymatic attack. Typically, during aerobic digestion in a process known as endogenous decay, as an available food substrate is depleted, the microorganisms begin to consume their own protoplasm to obtain energy for cell maintenance reactions.

One consequence of butane availability (cycling or pulsing) will be to accelerate oxidation of the organic matter by reducing endogenous decay. That is, the availability of a soluble food substrate will increase the survivability, and perhaps, the longevity of bacterial cells. In addition, the generation and expression of broadly specific, butane-induced enzymes capable of degrading or initiating the breakdown of more complex and less accessible organic materials will be an added benefit. Many complex compounds are more amenable to biological degradation (or direct microbial metabolism) after a cometabolic or enzymatic attack has initiated breakdown processes. Another benefit of butane availability will be the increase in cell densities and the microbiological diversity resulting under butane tension. This increased microbiological community will further enhance organic matter digestion.

During accelerated microbiological digestion, the decomposing organic material (for example, leaves taken from a compost pile) undergoes aerobic oxidation processes via butane/air cycling to produce stable organic matter through the production of polysaccharides, hemicellulose, cellulose and other microbial cell components and metabolic products resulting from the activities of heterotrophic bacteria. Butane availability will shorten the lag phase by acclimating (and stabilizing) the microbial populations in the organic material. With the microbial populations stabilized during pulsed cycles of butane and air (or oxygen), the entire microbial community will be better adapted for decompositional processes.

Because of its solubility, pulsed cycles of butane will adapt the microbial populations to better utilize the available carbon substrates remaining in the decomposing organic material, thereby accelerating the overall decompositional processes. Butane can be pulsed (supplied intermittently) to create feeding/starvation cycles. During the starvation cycle, the increased microbial populations (a larger percentage of the population containing butane-utilizing bacteria or heterotrophic bacteria) will be forced to consume and mineralize the remaining organic substrates possessing varying microbial availabilities at biological rates that would exceed conventional treatment processes. The process will continue to produce organic material that is very resistant to microbial and enzymatic degradation.

Butane availability will reverse the effects of limitations in the food supply (ever increasingly resistant organic material), thereby increasing or maintaining the rate of bacterial mass. As the readily available sources diminish, the more recalcitrant carbon sources remain in the organic mix. This in turn causes a decrease in the bacterial mass. Butane pulsing will offset the effects of carbon source availability by constantly reinforcing and strengthening the adapted microbial populations. The adapted populations will attack the remaining carbon sources (partially degraded through cometabolic or other microbial/enzymatic processes) during the starvation cycles, which in turn will accelerate the humification process, which is a major step in soil formation. As shown in FIG. 1, the microbiologically accelerated humus (MAH) may then undergo a mixing process to produce an agricultural-grade topsoil. Long term tumbling of the mineral fraction may mimic the effects of advanced geological weathering processes found in nature to produce geologically accelerated mineral fractions.

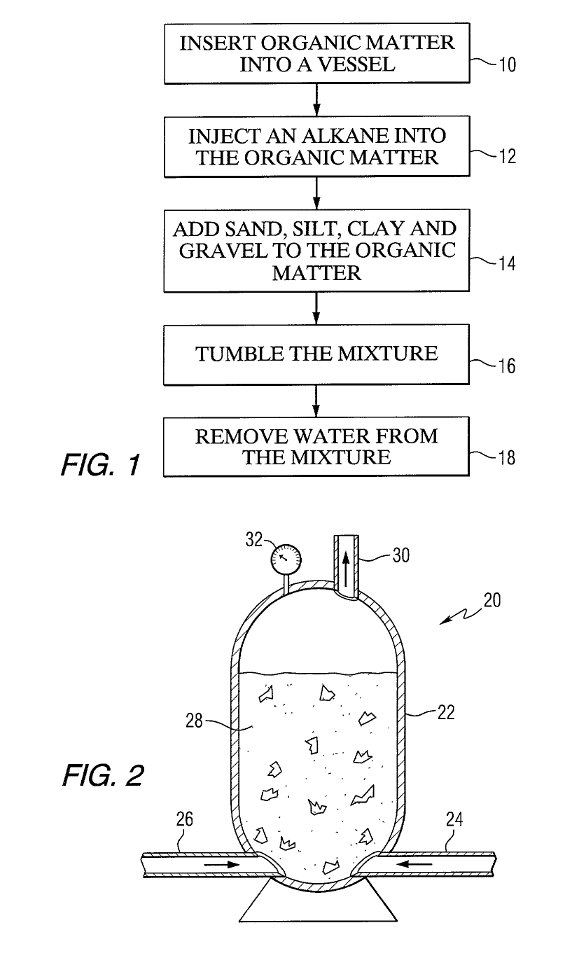

FIG. 2 is a schematic representation of a butane aerobic digester 20 that may be used in the performance of the method of the present invention. The digester includes a vessel 22 having means for injecting an oxygen-containing gas in the form of a first inlet 24, and a means for injecting an alkane in the form of a second inlet 26. Organic matter 28 is contained within the digester such that the oxygen-containing gas and the alkane pass through the organic matter. A vent 30 is provided to remove excess gasses from the digester. A pressure gauge 32 can be used to monitor the pressure within the digester. While FIG. 2 shows an aerobic digester, the method of this invention can utilize aerobic and/or anaerobic microorganisms found naturally in decomposing organic material. For anaerobic digestion, the first inlet can be disabled.

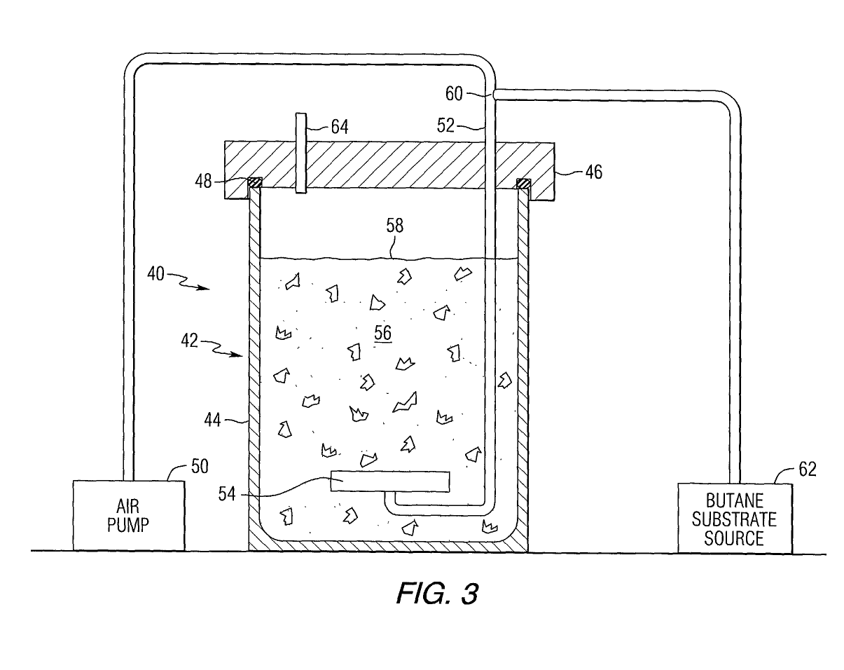

FIG. 3 is a schematic representation of another digester 40 that may be used in the performance of an embodiment of the method of the present invention. Digester 40 comprises a butane-enhanced bioreactor vessel 42 including a container 44 and cover 46 with a gasket 48 between the container and the cover. An air supply pump 50 pumps air through a pipe 52. One or more air diffuser(s) 54 are connected to the pipe to distribute the air within the organic matter 56. The organic matter can contain both solid and liquid phases. In this example, the organic matter includes a liquid defining a liquid level 58. An injection port 60 is provided in the pipe 52 so that butane from a butane source 62 can be injected into the organic matter. A vent 64 provides a means for venting gasses from the container.

The method of this invention encompasses aerobic and/or anaerobic treatment of organic material, such as tree leaves collected from a compost pile. Alternative arrangements for producing MAH include larger scale composting systems modified to include air and alkane injection systems. In one embodiment, a butane substrate is injected into the decomposing material within a large treatment vessel. The vessel can be equipped with oxygen injectors, water and turbulent mixing devices.

Bacteria used in accordance with the present invention may include the following Groups (in addition to fungi, algae, protozoa, rotifers and other microbial populations found in organic matter):

| | |
|---|---|
| Group 1: | The Spirochetes |
| Group 2: | Aerobic/Microaerophilic, motile, helical/vibroid, |
| | gram-negative bacteria |
| Group 3: | Nonmotile (or rarely motile), gram-negative bacteria |
| Group 4: | Gram-negative aerobic/microaerophilic rods and cocci |
| Group 5: | Facultatively anaerobic gram-negative rods |
| Group 6: | Gram-negative, anaerobic, straight, curved, and helical |
| | bacteria |
| Group 7: | Dissimilatory sulfate- or sulfur-reducing bacteria |
| Group 8: | Anaerobic gram-negative cocci |
| Group 10: | Anoxygenic phototrophic bacteria |
| Group 11: | Oxygenic phototrophic bacteria |
| Group 12: | Aerobic chemolithotrophic bacteria and associated |
| | organisms |
| Group 13: | Budding and/or appendaged bacteria |
| Group 14: | Sheathed bacteria |
| Group 15: | Nonphotosynthetic, nonfruiting gliding bacteria |
| Group 16: | The fruiting, gliding bacteria and the Myxobacteria |
| Group 17: | Gram-positive cocci |
| Group 18: | Endospore-forming gram-positive rods and cocci |
| Group 19: | Regular, nonsporing, gram-positive rods |
| Group 20: | Irregular, nonsporing, gram-positive rods |
| Group 21: | The mycobacteria |
| Groups 22-29: | The actinomycetes |
| Group 22: | Nocardioform actinomycetes |
| Group 23: | Genera with multiocular sporangia |
| Group 24: | Actinoplanetes |
| Group 25: | Streptomycetes and related genera |
| Group 26: | Maduromycetes |
| Group 27: | Thermomonospora and related genera |
| Group 28: | Thermoactinomycetes |
| Group 29: | Genus Glycomyces, Genus Kitasatospira and Genus |
| | Saccharothrix |
| Group 30: | The Mycoplasmas - cell wall-less bacteria |
| Group 31: | The Methanogens |
| Group 32: | Archaeal sulfate reducers |
| Group 33: | Extremely halophilic, archaeobacteria (halobacteria) |
| Group 34: | Cell wall-less archaeobacteria |
| Group 35: | Extremely thermophilic and hyperthermophilic S⁰- |
| | metabolizers |

Facultative anaerobes and microaerophilic may also be used. These are bacteria capable of surviving at low levels of oxygen. They do not require strict anaerobic conditions such as the obligate anaerobes. They include acidophilic, alkaliphilic, anaerobe, anoxygenic, autotrophic, chemolithotrophic, chemoorganotroph, chemotroph, halophilic, methanogenic, neutrophilic, phototroph, saprophytic, thermoacidophilic and thermophilic bacteria.

U.S. Pat. Nos. 5,888,396, 6,051,130 and 6,210,579, which are incorporated herein by reference, disclose bacteria which may be used in accordance with the present invention to produce microbiologically accelerated humus.

Degradation of complex organic matter in the digester preferably requires the interaction of microbial populations (consortia). Butane or alkane-utilizing bacteria may degrade materials aerobically (or anaerobically) through direct metabolism, sequential metabolism, reductive metabolism, or cometabolism.

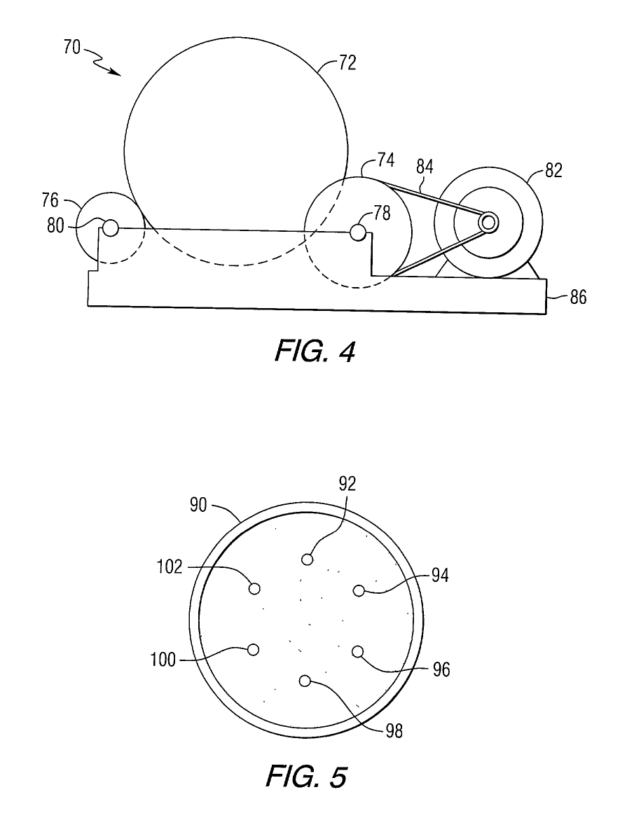

The digestion process produces a microbiologically accelerated humus (MAH). The MAH can include a liquid phase and a solid phase (sludge). In accordance with an embodiment of the invention, the MAH may then be subjected to a mixing process to produce an agricultural-grade topsoil. FIG. 4 is a schematic representation of a tumbler 70 that may be used to perform the mixing step of this embodiment. The tumbler includes a drum 72 mounted between a drive wheel 74 and a guide wheel 76. The drive wheel is mounted on an axle 78 and the guide wheel is mounted on an axle 80. An electric motor 82 is connected to the drive wheel by a drive belt 84. The axles and motor are supported by a base 86.

The MAH can be placed in the drum of the tumbler along with for example, sand, silt, and/or clay powder. The silt component can be created by mechanical crushing of sand particles to sizes less than 0.05 millimeters. The sand, silt and clay fractions are introduced into the tumbler chamber with the MAH obtained from the accelerated digestion, along with a gravel component. The gravel component enhances mixing and enhances, or mimics, advanced geologic weathering processes. The tumbling process thoroughly mixes the organic and mineral fractions and, in the process, releases into solution organic acids and ions which improve soil fertility. The tumbling cycle may last from less than one week to one year or more, for example, two, four or six months. For longer periods, the motion and interaction of the mineral components within the tumbler chamber have the potential to mimic the effects of advanced geological weathering processes found in nature to produce a geologically accelerated mineral fraction.

Examples of material mixes and periods of operation for three tumblers are described below. The example times are listed for convenience only and do not represent optimized process and system specifications.

Tumbler #1: One Liter of MAH; 320 grams of silt (crushed sand), 160 grams of sand (coarse 0.5-1.0 mm), 80 grams of bentonite powder (a colloidal clay made up of the mineral sodium montmorillonite, a hydrated aluminum silicate); 300 grams of washed stone (angular). Period of operation is 2 months.

Tumbler #2: One Liter of MAH; 320 grams of silt (crushed sand), 160 grams of sand (coarse 0.5-1.0 mm), 80 grams of bentonite powder (a colloidal clay made up of the mineral sodium montmorillonite, a hydrated aluminum silicate); 300 grams of washed stone (angular). Period of operation is 4 months.

Tumbler #3: One Liter of MAH; 320 grams of silt (crushed sand), 160 grams of sand (coarse 0.5-1.0 mm), 80 grams of bentonite powder (a colloidal clay made up of the mineral sodium montmorillonite, a hydrated aluminum silicate); 300 grams of washed stone (angular). Period of operation is 6 months.

At the conclusion of the tumbling process excess moisture can be removed from the mixture. For example, the soil material can be poured into a shallow tray, and the excess water can be allowed to evaporate by standing. Alternatively, the MAH and the intimately mixed mineral fraction can be placed into an evaporator to remove the excess water. The final soil product can then undergo detailed soil chemical analysis. The results of the analysis may be compared, for example, to those of a high grade Iowa agricultural topsoil.

A portion of the soil material left behind after evaporation may be submitted to a soil testing laboratory and analyzed for the following parameters: cation exchange capacity (CEC); pH, lime index, phosphorus, potassium, calcium, magnesium, percent organic matter, percent sand, percent silt, percent clay, cellulose, hemicellulose, lignin, protein, fats, waxes, alkalinity, carbonate, and aluminum. The results of the analytical testing of the produced soil material may be compared to agricultural topsoil. Growth testing of the produced soil material may be performed. For example, the soil material collected after the evaporative process may be placed in a planter with kernels of corn.

The invention has been performed using compost material collected from a backyard compost pile located in Massachusetts. The material included leaves and grass clippings, which had accumulated over a period of two months. The organic material had undergone some decomposition, but the structures of the leaves and grass were still clearly discernible. The compost material was introduced into a five-gallon bioreactor vessel constructed of high-density polyethylene plastic, HDPE. A bioreactor as shown in FIG. 3 was constructed with the following components: twin aeration diffusers (200 liters/hour), an air-supply pump, vent line, and syringe port equipped with Teflon-coated septum for butane injections.

The bioreactor contained approximately 5 gallons of water/compost mixture, which included 3.75 gallons of tap water with the addition of the composted leaves and grass. Prior to the butane injections, the contents were thoroughly mixed. After mixing, the structures of the leaves and grass were still clearly discernible. The aeration system was operated continually (200 liters per hour) with periodic stops to conduct butane injections. The butane was injected into a syringe port connected to the air-supply line, as shown in FIG. 3, at intervals shown in Table 1. After a period of approximately seventy-one days, the butane injections were halted. During the hours not shown on the table, the bioreactor was operated with aeration without butane injection thereby creating feeding/starvation cycles. This cycling best maximizes the production of the key enzymes and enhances or accelerates organic matter degradation.

TABLE 1
Butane Injection Schedule

| | | | | Aeration |
|---|---|---|---|---|
| | | Volume of | Aeration | Restarted |
| Day No. | Time | Butane | Shut off | (200 L/hr) |
| 1 | 12:00 | 50 ml | N/A | On |
| 2 | 16:15 | 80 ml | N/A | On |
| 3 | 16:55 | 50 ml | N/A | On |
| 4 | 16:30 | 50 ml | N/A | On |
| 9 | 16:45 | 75 ml | N/A | On |
| 10 | 13:00 | 50 ml | N/A | On |
| 11 | 13:18 | 250 ml | N/A | On |
| 12 | 14:15 | 275 ml | 14:15 | 15:15 |
| 15 | 11:30 | 350 ml | 11:30 | 13:30 |
| 16 | 12:30 | 300 ml | 12:30 | 13:30 |
| 22 | 16:00 | 300 ml | 16:00 | 17:00 |
| 23 | 18:00 | 300 ml | 18:00 | 19:00 |
| 24 | 17:00 | 300 ml | 17:00 | 18:00 |
| *30 | 17:22 | 300 ml | 17:22 | 18:22 |
| 31 | 16:00 | 300 ml | 16:00 | 17:00 |
| 33 | 16:15 | 300 ml | 16:15 | 17:15 |
| 37 | 19:28 | 300 ml | 19:28 | 20:28 |
| 38 | 17:29 | 300 ml | 17:29 | 18:29 |
| 39 | 19:11 | 300 ml | 19:11 | 20:11 |
| 40 | 14:40 | 300 ml | 14:40 | 15:40 |
| 41 | 20:00 | 400 ml | N/A | On |
| 44 | 14:56 | 300 ml | 14:56 | 15:56 |
| 45 | 17:18 | 300 ml | 17:18 | 18:18 |
| 46 | 14:12 | 300 ml | 14:12 | 15:12 |
| 47 | 18:00 | 300 ml | 18:00 | 19:00 |
| 48 | 17:00 | 300 ml | 17:00 | 18:00 |
| 51 | 16:40 | 300 ml | 16:40 | 17:40 |
| 52 | 17:10 | 300 ml | 17:10 | 18:10 |
| 54 | 14:20 | 300 ml | 14:20 | 15:20 |
| 55 | 15:30 | 300 ml | 15:30 | 16:30 |
| 58 | 11:55 | 300 ml | 11:55 | 12:55 |
| 59 | 14:16 | 300 ml | 14:16 | 15:16 |
| 60 | 16:00 | 300 ml | 16:00 | 17:00 |
| 61 | 17:30 | 300 ml | 17:30 | 18:30 |
| 62 | 17:55 | 300 ml | 17:55 | 18:55 |
| 65 | 18:15 | 500 ml | 18:15 | 19:15 |
| 66 | 14:40 | 500 ml | 14:40 | 15:40 |
| 72 | 08:19 | 500 ml | 08:19 | 09:19 |
| 73 | 10:31 | 500 ml | 10:31 | 11:31 |

On Day No. 30, 54 fluid oz. tap water was added to the bioreactor to restore the fluid level to its original level.

On Day No. 76, the contents of the bioreactor were strained to separate the liquid and solid material. The straining process yielded approximately 3.5 gallons of a solution of dark brown to black organic liquor (microbiologically accelerated humus—MAH) and approximately 1,500 grams of a solid dark brown to black organic sludge (sludge) with a significantly reduced number of discernible leaf or grass structures.

Two tumblers were prepared, as illustrated in FIG. 4, each equipped with a one-quart chamber. Both chambers were filled with a mixture including of 500 grams of the black organic sludge, 100 grams of clay (bentonite), 200 grams of silt, 200 grams of fine dry sand, 200 grams of granite stones (for grinding) and approximately 250 ml of the black organic liquor (MAH). The fine sand and silt were obtained by sifting commercial bagged sand through Hubbard Scientific Screen Sieves to isolate for fine sand (#230 mesh) and silt. The two tumblers were sealed and operated continuously for a period of 72 hours to thoroughly mix the one-quart chamber contents.

On Day No. 79, the tumbler chambers were opened and the topsoil mixture was poured onto two shallow aluminum trays to air dry at approximately 80° Fahrenheit for 48 hours. The granite stones were removed by hand. On Day No. 81, the dried topsoil mixture was crumbled by hand, watered with 100 ml tap water and then mixed by hand to a consistency between that of Iowa crop soil and ornamental topsoil.

Five Nalgene plastic grow pots, approximately 11 cm. in diameter and 6.5 cm. deep, were prepared with four 0.2 cm drainage holes drilled in each base. Each of the five pots was filled with approximately 617 cm³ of a soil sample and labeled as described in Table 2. Each soil sample was tested for pH using a Chemetrics pH meter dipped in a mixture of 40 ml distilled water and 100 grams of soil.

TABLE 2
Soil Composition

| Sample | Contents |
|---|---|
| Compost Undigested | 50% Undigested Compost, 20% sand, 20% |
| | silt, 10% clay |
| Digested Compost | 100% Sludge MAH |
| Engineered Topsoil | 50% Digested Compost, 20% sand, 20% |
| | silt, 10% clay |
| Iowa Crop Soil | 100% Iowa Crop Soil (high clay content) |
| Ornamental Topsoil | 100% Purchased Topsoil |

The undigested compost was reserved from the original Massachusetts “backyard” compost sample. The sand was tropical Caribbean sterilized sand. The Iowa crop soil was collected from an Iowa commercial cornfield that was growing a corn crop at the time of collection. The ornamental topsoil was commercially available under the designation Earthgro Topsoil.

As shown in FIG. 5, each container 90 containing a soil sample was seeded with three varieties of beans (improved tendergreen, goldcrop wax, pencilpod wax) and three varieties of sweet corn (sugar dots, silver queen hybrid, jubilee) planted in a radial pattern at a depth of approximately 2.5 cm, at locations 92, 94, 96, 98, 100 and 102. Each soil sample was then watered with 140 ml tap water and positioned on its own drainage tray on a shelf approximately 30 cm below a 33 watt grow light (no sunlight) equipped with a timer set for 16 hours light on, 6 hours light off. White reflective covering was placed on the wall immediately behind the samples, with an aluminum foil hood extending over the light fixture to reflect light downward onto the pots. Table 3 shows the germination successes/failures of the six seed varieties planted in each pot (seeds unearthed/examined on Day No. 91). Seedling height for each variety that grew above soil surface is recorded in Table 4 (first seedlings visible on Day No. 83). The watering regime and ambient temperatures are recorded in Table 5.

TABLE 3
Seed Germination Successes/Failures

| | Engineered | Iowa Crop | Digested | Compost | Ornamental |
|---|---|---|---|---|---|
| | Topsoil | Soil | Compost | Undigested | Topsoil |
| Soil pH | 7.5 | 7.2 | 7.1 | 7.1 | 6.5 |
| Sweet Corn Jubilee | + | — | — | + | — |
| Sweet Corn Sugar Dots | ++ | + | — | ++ | — |
| Sweet Corn Silver Queen | + | + | + | + | + |
| Beans Goldcrop Wax | + | — | + | + | + |
| Beans Pencilpod Wax | ++ | ++ | ++ | + | + |
| Beans Tendergreen | + | — | + | ++ | + |

In Table 3,+ indicates that the seed germinated, ++ indicates that the seedling sprouted (grew above soil surface), and −−−− indicates that the seed did not germinate.

TABLE 4
Seedling Height

| Seed Variety | Engineered | Iowa Crop | Digested | Compost | Ornamental |
|---|---|---|---|---|---|
| Day No. | Topsoil | Soil | Compost | Undigested | Topsoil |
| Sweet Corn | | | | | |
| Sugar Dots | | | | | |
| 81 planted | | | | | |
| 82 | | | | | |
| 83 | | | | | |
| 84 | | | | | |
| 85 | 1.5 cm | | | 0.6 cm | |
| 86 | 4.0 cm | | | 2.0 cm | |
| 87 | 6.0 cm | | | 3.6 cm | |
| 88 | 7.7 cm | | | 4.6 cm | |
| Beans | | | | | |
| Pencilpod | | | | | |
| Wax | | | | | |
| 81 planted | | | | | |
| 82 | | | | | |
| 83 | | | | | |
| 84 | | 0.1 cm | | | |
| 85 | | 0.9 cm | 0.9 cm | | |
| 86 | 2.3 cm | 15.0 cm tall | 15.8 cm tall | | |
| | | w/2 leaves | w/2 leaves | | |
| | | folded- | folded- | | |
| | | 3 cm long | 3.2 cm long | | |
| 87 | 3.8 cm | 17.7 cm tall | 16.8 cm tall | | |
| | | w/2 leaves | w/2 leaves | | |
| | | 5.0 × 3.0 cm | 6.0 × 3.1 cm | | |
| | | 4.8 × 3.1 cm | 5.0 × 3.5 cm | | |
| 88 | 13.1 cm | 19.5 cm tall | 17.0 cm tall | | |
| | w/2 leaves | w/2 leaves | w/2 leaves | | |
| | folded 3 cm | 7.2 × 5.1 cm | 5.6 × 4.1 cm | | |
| | long | 7.4 × 4.6 cm | 6.2 × 4.0 cm | | |
| Beans | | | | | |
| Tendergreen | | | | | |
| 81 planted | | | | | |
| 82 | | | | | |
| 83 | | | | | |
| 84 | | | | | |
| 85 | | | | | |
| 86 | | | | | |
| 87 | | | | 0.3 cm | |
| 88 | | | | 3.9 cm | |
| Other | (2 shoots) | | (>50 shoots) | (3 shoots) | |
| Grass | | | | | |
| 81 | | | | | |
| 82 | | | | | |
| 83 | | | 2.5 cm | | |
| 84 | | | 2.7 cm | | |
| 85 | | | 2.9 cm | 0.5 cm | |
| 86 | | | 3.0 cm | 1.5 cm | |
| 87 | | | 3.0 cm | 2.0 cm | |
| 88 | 0.5 cm | | 3.0 cm | 2.0 cm | |

TABLE 5
Watering Regime

| | | Ambient | Water added to each |
|---|---|---|---|
| Day No. | Time | Temp. ° F. | sample |
| 81 | 19:00 | 80 | 140 ml |
| 82 | 18:00 | 80 | 40 ml |
| 83 | 17:00 | 82 | 40 ml |
| 84 | 17:00 | 80 | — |
| 85 | 12:30 | 78 | — |
| 86 | 18:15 | 80 | 40 ml |
| 87 | 18:00 | 82 | — |
| 88 | 13:30 | 79 | 50 ml |

The engineered topsoil had a relatively high pH (7.5), perhaps due to limestone content in stones used in the tumbler. At the end of the eight-day period the seeds/seedling roots were unearthed and examined. All six seed varieties germinated in the engineered topsoil, as well as in the undigested compost. The digested compost and ornamental topsoil germinated 4 varieties (three bean and one corn), while the Iowa crop soil germinated three varieties (two corn, one bean).

The pencilpod wax bean seeds sprouted (grew above the soil surface) in the engineered topsoil, Iowa crop soil and digested compost. By the end of the eight-day growth period, the seedling grown in Iowa soil had reached a height of 19.5 cm, while the engineered topsoil and digested compost seedlings were 13.1 cm and 17.0 cm in height, respectively. In all three samples, seedling color, leaf dimensions and thickness of stalk were consistent. While the Iowa seedling grew the tallest, it sprouted only that one variety. The engineered topsoil sprouted a second variety, sweet corn—sugar dots, and, by the eighth day was sprouting grass seedlings. The digested compost also sprouted grass seedlings (more than 50) in addition to the bean, from two days after planting through eight days after planting.

The roots of the pencilpod wax beans developed the fastest in the Iowa soil. That is, it was the first sample to have roots appear on the clear base of the pot, and to a wide degree horizontally against the sides of the pot, which may have hindered the germination/growth of neighboring seed varieties due to competition for water and nutrients. The Iowa sample germinated the fewest seeds. The root systems of the same bean variety in the engineered topsoil and digested compost developed to a very similar extent (to each other), more vertically than horizontally in the soil. These samples both germinated more seed varieties that the Iowa crop soil, indicating, at least initially, a more even usage of water and nutrients among the seeds.

Though all samples received the same amount of water, there were differences in the amount of water that drained through each pot into the drainage tray following each watering event. Any water that drained through the soil was poured back over the surface. The engineered topsoil and digested compost samples were the best at retaining water. Their trays were consistently dry following each watering event. The Iowa crop soil drained approximately 1 -10 ml after each event, while the undigested compost and ornamental topsoil samples each drained at least 20 ml after watering.

Under less than optimal conditions, the engineered topsoil successfully germinated all seeds planted, and began to grow two apparently healthy vegetable varieties, bean (pencilpod wax) and sweet corn (sugar dots), as well as grass seedlings. The bean that grew in the engineered topsoil exhibited the same color, and dimensions proportional to those of the bean grown in the Iowa crop soil, although the engineered topsoil bean appeared two days after the first showing of the bean grown in the Iowa sample. Although the distribution (vertical and horizontal) and overall length of the root systems were different for the engineered topsoil and digested compost samples, as opposed to the Iowa sample, the thickness, color and complexity of the root branches were very similar.

The bean grown in the digested compost was very close in growth rate to that of the Iowa sample bean. The digested compost was successful at germinating certain grass seeds naturally found in the original compost material.

The engineered topsoil and the digested compost each had a higher capacity for holding water than the Iowa crop soil, while the digested compost was lighter in weight than the engineered topsoil, even in a saturated state. The undigested compost and ornamental topsoil each had a relatively poor capacity for retaining water.

The engineered topsoil contained only 50% MAH. Engineered topsoil can be optimized for crop growth by increasing the percentage of MAH mixed with the mineral fraction. Had the percentage of liquid MAH and sludge MAH been increased in the blend, and the pH lowered, the growth performance characteristics for the various seedlings may have significantly exceeded those for the Iowa crop soil. In addition, the mineral fraction may be altered for improved performance, such as decreasing the percentage of clay while increasing the silt fraction. Optimization of the engineered topsoil was not considered for this experiment. The (soil-less) digested compost demonstrated excellent potential comparable to the Iowa crop soil. Commercial greenhouses today often utilize soil-less growth media high in organic matter to enhance plant growth. Soil-less media are also attractive to wholesale greenhouse growers because they are lightweight, allowing for reduced shipping costs for potted plants. The MAH may be used as a soil-less media to grow plants in commercial greenhouses, or may be bagged and sold as potting soil. Commercial potting soils are often organic matter, such as peat moss or bark based, mixed with drainage material, such as vermiculite or perlite, and some starter fertilizer.

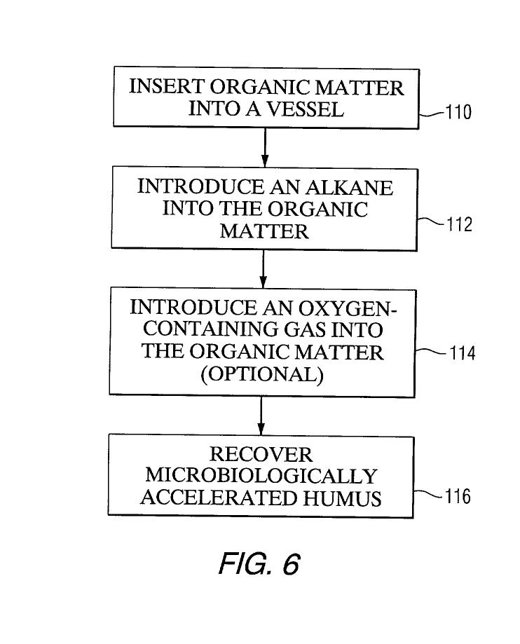

The microbiologically accelerated humus can also be prepared without the mineral fraction to produce a soil-less mixture (such as the digested compost) suitable for use at commercial greenhouses or similar applications. FIG. 6 is a flow diagram showing the steps used to produce microbiologically accelerated humus in accordance with an embodiment of the present invention. Block 110 shows that organic matter can initially be placed in a vessel. The organic matter can be any of the various types of organic matter discussed above, but preferably can be compost material, plant material or cellulosic material. An alkane is introduced into the organic matter as shown in block 112. The microbiologically accelerated humus can be produced through either an aerobic or an anaerobic process. If an aerobic process is desired, an oxygen-containing gas may optionally be introduced into the organic matter as shown in block 114. The microbiologically accelerated humus is then recovered from the vessel as shown in block 116.

Water can be added to the organic matter in the vessel. The water and organic matter comprise a digestion mass. The digestion mass can include between about 25 weight percent and about 99.9 weight percent water, and more preferably between about 50 weight percent and about 99 weight percent water. In an alternative embodiment the digestion mass can include less than about 50 weight percent water, e.g. from about 5 to about 40 weight percent water. In this embodiment, the organic matter may be immersed in the water, or a mound or pit containing the organic matter may be periodically sprayed with water to maintain the desired moisture content.

While particular embodiments of this invention have been described above for purposes of illustration, it will be evident to those skilled in the art that numerous variations of the details of the described embodiments may be made without departing from the invention. For example, alkane injection maybe used to enhance conventional composting systems or processes.

What is claimed is:

1. A process for producing microbiologically accelerated humus comprising introducing an alkane and an oxygen-containing gas into organic matter to produce the microbiologically accelerated humus.

2. The process of claim 1, wherein the alkane is introduced intermittently.

3. The process of claim 1, wherein the alkane comprises a butane substrate.

4. The process of claim 3, wherein the butane substrate comprises at least about 50 weight percent butane.

5. The process of claim 3, wherein the butane substrate comprises at least about 90 weight percent butane.

6. The process of claim 3, wherein the butane substrate comprises at least about 99 weight percent n-butane.

7. The process of claim 3, wherein the butane substrate comprises at least one of n-butane and iso-butane.

8. The process of claim 1, further comprising mixing the microbiologically accelerated humus with a geologic mineral fraction.

9. The process of claim 8, wherein the geologic mineral fraction comprises sand, silt, clay and/or gravel.

10. The process of claim 9, wherein the step of mixing a geologic mineral fraction with the microbiologically accelerated humus comprises tumbling a mixture of the microbiologically accelerated humus, sand, silt, clay and/or gravel.

11. The process of claim 8, further comprising removing excess water from the mixture of microbiologically accelerated humus, sand, silt, clay and/or gravel.

12. The process of claim 1, wherein the organic matter comprises compost material, plant material and/or cellulosic material.

13. A microbiologically accelerated humus produced by the process of claim 1.

14. A system for producing microbiologically accelerated humus comprising:
means for introducing an oxygen-containing gas into organic matter; and
means for introducing an alkane into the organic matter to produce the microbiologically accelerated humus.

15. The system of claim 14, wherein the alkane is introduced intermittently.

16. The system of claim 14, wherein the alkane comprises a butane substrate.

17. The system of claim 16, wherein the butane substrate comprises at least about 50 weight percent butane.

18. The system of claim 16, wherein the butane substrate comprises at least about 90 weight percent butane.

19. The system of claim 16, wherein the butane substrate comprises at least about 99 weight percent n-butane.

20. The system of claim 16, wherein the butane substrate comprises at least one of n-butane and iso-butane.

21. The system of claim 14, further comprising:
means for mixing the microbiologically accelerated humus with a geologic mineral fraction.

22. The system of claim 21, wherein the means for mixing the microbiologically accelerated humus with a geologic mineral fraction comprises:
means for tumbling the mixture of microbiologically accelerated humus and the geologic mineral fraction.

23. A process for producing microbiologically accelerated humus comprising introducing a butane substrate into organic matter to accelerate microbiologic activity in the organic matter.

24. The process of claim 23, wherein the butane substrate is introduced intermittently.

25. The process of claim 23, wherein the butane substrate comprises at least about 50 weight percent butane.

26. The process of claim 23, wherein the butane substrate comprises at least about 90 weight percent butane.

27. The process of claim 23, wherein the butane substrate comprises at least about 99 weight percent n-butane.

28. The process of claim 23, wherein the butane substrate comprises at least one of n-butane and iso-butane.

29. The process of claim 23, further comprising introducing an oxygen-containing gas into the organic matter.

30. The process of claim 23, further comprising mixing the organic matter with a geologic mineral fraction.

31. The process of claim 23, wherein the organic matter comprises compost material, plant material and/or cellulosic material.

32. A microbiologically accelerated humus produced using the process of claim 23.

33. A system for producing microbiologically accelerated humus comprising:
means for introducing a butane substrate into organic matter to accelerate microbiologic activity in the organic matter.

34. The system of claim 33, wherein the means for introducing a butane substrate into the organic matter comprises:
a vessel for containing the organic matter;
an inlet for receiving the butane substrate; and
a diffuser for diffusing the butane substrate in the organic matter; and
a composting system modified to introduce butane and air to the mix.

35. The system of claim 33, wherein the butane substrate is introduced intermittently.

36. The system of claim 33, wherein the butane substrate comprises at least about 50 weight percent butane.

37. The system of claim 33, wherein the butane substrate comprises at least about 90 weight percent butane.

38. The system of claim 33, wherein the butane substrate comprises at least about 99 weight percent n-butane.

39. The system of claim 33, wherein the butane substrate comprises at least one of n-butane and iso-butane.

40. The system of claim 33, further comprising:
means for introducing an oxygen-containing gas into the organic matter.

41. The system of claim 33, further comprising:
means for mixing the organic matter with a geologic mineral fraction.

42. A process for producing soil comprising introducing an alkane into organic matter to produce microbiologically accelerated humus, and mixing the microbiologically accelerated humus with a geologic mineral fraction.

43. The process of claim 42, wherein the mixing follows the introduction of alkane.

44. The process of claim 42, wherein the introduction of alkane and the mixing are performed concurrently.

45. The process of claim 42, wherein the alkane is introduced intermittently.

46. The process of claim 42, wherein the alkane comprises a butane substrate.

47. The process of claim 46, wherein the butane substrate comprises at least about 50 weight percent butane.

48. The process of claim 46, wherein the butane substrate comprises at least about 90 weight percent butane.

49. The process of claim 46, wherein the butane substrate comprises at least about 99 weight percent n-butane.

50. The process of claim 46, wherein the butane substrate comprises at least one of n-butane and iso-butane.

51. The process of claim 42, further comprising introducing an oxygen-containing gas into the organic material.

52. The process of claim 42, wherein the mineral fraction comprises sand, silt, clay and/or gravel.

53. The process of claim 52, wherein the step of mixing a geologic mineral fraction with the microbiologically accelerated humus comprises tumbling a mixture of the microbiologically accelerated humus, sand, silt, clay and/or gravel.

54. The process of claim 53, further comprising the step of removing excess water from the mixture.

55. The process of claim 42, wherein the organic matter comprises compost material, plant material and/or cellulosic material.

56. A topsoil produced using the process of claim 42.

57. A system for producing soil comprising:
means for introducing an alkane into organic matter to produce microbiologically accelerated humus; and
means for mixing the microbiologically accelerated humus with a geologic mineral fraction.

58. The system of claim 57, wherein the alkane is introduced intermittently.

59. The system of claim 57, wherein the alkane comprises a butane substrate.

60. The system of claim 59, wherein the butane substrate comprises at least about 50 weight percent butane.

61. The system of claim 59, wherein the butane substrate comprises at least about 90 weight percent butane.

62. The system of claim 59, wherein the butane substrate comprises at least about 99 weight percent n-butane.

63. The system of claim 59, wherein the butane substrate comprises at least one of n-butane and iso-butane.

64. The system of claim 57, wherein the means for mixing the microbiologically accelerated humus with the geologic mineral fraction comprises:
means for tumbling the mixture of microbiologically accelerated humus and the geologic mineral fraction.

65. The system of claim 57, further comprising:
means for introducing an oxygen-containing gas into the organic matter.

66. A process for producing microbiologically accelerated humus comprising introducing an alkane into organic matter to produce the microbiologically accelerated humus, wherein the organic matter includes compost material, plant material and/or cellulosic material.

67. The process of claim 66, wherein the alkane is introduced intermittently.

68. The process of claim 66, wherein the alkane comprises a butane substrate.

69. The process of claim 68, wherein the butane substrate comprises at least about 50 weight percent butane.

70. The process of claim 68, wherein the butane substrate comprises at least about 90 weight percent butane.

71. The process of claim 68, wherein the butane substrate comprises at least about 99 weight percent n-butane.

72. The process of claim 68, wherein the butane substrate comprises at least one of n-butane and iso-butane.

73. The process of claim 66, further comprising introducing an oxygen-containing gas into the organic matter.

74. The process of claim 66, further comprising mixing the microbiologically accelerated humus with a geologic mineral fraction.

75. The process of claim 74, wherein the mineral fraction comprises sand, silt, clay and/or gravel.

76. The process of claim 74, wherein the step of mixing a geologic mineral fraction with the microbiologically accelerated humus comprises the step of tumbling a mixture of the microbiologically accelerated humus and the geologic mineral fraction.

77. The process of claim 76, further comprising the steps of removing excess water from the mixture of microbiologically accelerated humus and the geologic mineral fraction.

78. A microbiologically accelerated humus produced by the process of claim 66.

79. A microbiologically accelerated humus comprising alkane-treated dewatered organic matter.

80. The microbiologically accelerated humus of claim 79, wherein the organic matter includes compost material, plant material and/or cellulosic material.

81. A digestion mass comprising:
alkane-using bacteria and organic matter.

82. The digestion mass of claim 81, wherein the organic matter includes compost material, plant material and/or cellulosic material.

83. The digestion mass of claim 81, further comprising water.

84. The digestion mass of claim 83, wherein the water comprises between about 25 weight percent and about 99.9 weight percent of the digestion mass.

85. The digestion mass of claim 83, wherein the water comprises between about 50 weight percent and about 99 weight percent of the digestion mass.

86. The digestion mass of claim 83, wherein the water comprises less than about 50 weight percent of the digestion mass.

87. A soil comprising:
microbiologically accelerated humus; and
a geologic mineral fraction.

88. The soil of claim 87, wherein the microbiologically accelerated humus comprises from about 5 to about 99 weight percent of the soil, and the geologic mineral fraction comprises from about 1 to about 95 weight percent of the soil.

89. The soil of claim 87, wherein the geologic fraction comprises:
sand, silt, clay and/or gravel.
